(19) United States
(12) Patent Application Publication
(10) Pub. No.: US 2015/0234804 A1
(43) Pub. Date: Aug. 20, 2015

(54) JOINT MULTIGRAM-BASED DETECTION OF SPELLING VARIANTS

(71) Applicant: GOOGLE INC., Mountain View, CA (US)

(72) Inventors: Matthew Nicholas Stuttle, Lewes (GB); Alexander Gutkin, Cambridge (GB)

(21) Appl. No.: 14/468,468

(22) Filed: Aug. 26, 2014

(30) Foreign Application Priority Data
Feb. 16, 2014 (IL) 230993

(51) Int. Cl. G06F 17/27; G06N 99/00; G06N 7/00

(52) U.S. Cl. CPC G06F 17/273; G06N 7/005; G06N 99/005

(57) ABSTRACT

Content processing includes receiving a set of a correctly spelled alert words and at least one spelling variant corresponding to each correctly spelled alert word; determining at least one alignment of joint multigrams for each correctly spelled alert word/corresponding spelling variant pair; training a model of correspondence between the set of received orthographic alert words and corresponding spelling variants using the determined alignments; and receiving a spelling variant observation from a content block. Using the trained model, the technology determines a probability that the received spelling variant observation corresponds to a received correctly spelled alert word. For a determined probability exceeding a configured threshold, the technology denies automatic acceptance of the content block.

### CROSS REFERENCE TO RELATED APPLICATIONS

This patent application claims priority to Israel Patent Application No. 230993, filed Feb. 16, 2014, and entitled “Joint Multigram-Based Detection of Spelling Variants.” The entire disclosure of the above-identified priority application is hereby fully incorporated herein by reference.

### TECHNICAL FIELD

The disclosed technology relates to detection of spelling variants in a content block, and more particularly to using joint multigrams to detect alert words and spelling variants thereof in a content block.

### BACKGROUND

Many online systems that accept user-generated content (for example, e-mail systems, e-commerce systems, and social networks) use keyword filtering to detect alert words that indicate inappropriate content. For example, inappropriate content can include spam. Typical keyword filtering relies on lists of both orthographic (correctly spelled) and variant spellings of the alert word. However, it is impractical for such approaches to cover all, or even a non-trivial percentage, of such variant spellings. For example, one commentator has identified over one quadrillion possible non-orthographic spelling variants of a well-known prescription medicine.

### SUMMARY

The technology described herein includes computer implemented methods, computer program products, and systems for processing a content block for correctly spelled alert words and spelling variants thereof. In certain example embodiments, a set of a correctly spelled alert words and at least one spelling variant corresponding to each correctly spelled alert word are received. At least one alignment of joint multigrams for each correctly spelled alert word/corresponding spelling variant pair is determined. A model of correspondence between the set of received correctly spelled alert words and corresponding spelling variants using the determined alignments is trained. A spelling variant observation is received from a content block, and using the trained model, a probability that the received spelling variant observation corresponds to a received correctly spelled alert word is determined. For a determined probability exceeding a configured threshold, automatic acceptance of the content block is denied.

In certain example embodiments, training includes applying expectation-maximization using alignment as the hidden variable. In some such embodiments, determining the probability that the received spelling variant observation corresponds to a received a correctly spelled alert word includes determining a posterior probability that the received spelling variant observation corresponds to the orthographic alert word.

In certain example embodiments, receiving a spelling variant observation from a content block includes receiving the content block and performing a spell check function on the content block to identify each incorrect spelling as a spelling variant observation.

In certain example embodiments, denying automatic acceptance includes transmitting the content block for further review; while in certain example embodiments, denying automatic acceptance includes rejecting the content block. In certain example embodiments, the spelling variant includes at least one of a non-printable character and a graphical element.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a communications and processing architecture for joint multigram-based detection of spelling variants, in accordance with certain example embodiments.

FIG. 2 is a block flow diagram depicting methods for joint multigram-based detection of spelling variants, in accordance with certain example embodiments.

FIG. 3 is a block flow diagram depicting methods for joint multigram-based detection of spelling variants, in accordance with certain example embodiments.

FIG. 4 is a block flow diagram depicting methods for joint multigram-based detection of spelling variants, in accordance with certain example embodiments

FIG. 5 is a block flow diagram depicting methods for joint multigram-based detection of spelling variants, in accordance with certain example embodiments.

FIG. 6 is a block flow diagram depicting methods for joint multigram-based detection of spelling variants, in accordance with certain example embodiments.

FIG. 7 is a block diagram depicting a computing machine and a module, in accordance with certain example embodiments.

### DETAILED DESCRIPTION OF THE EXAMPLE EMBODIMENTS

### Overview

The technology includes methods to create a trained probabilistic joint multigram generative model that learns the mapping between sub-word clusters in an alert word and the likely or possible variants that can be used to misspell the alert word. In certain example embodiments, an existing set of identified alert words and the alert word misspellings are used as input to train the joint multigram system where the source is the alert word (true orthography) and the misspelled word forms the observations. After training such a generative model, the likelihood of an observed sequence coming from a given alert word is be computed. Further observations and trained data are input for retraining, and new alert words are added using the existing generative models without the need for adding new training data. Learned misspellings and mappings also are shared across all possible alert words. The technology is used to detect, and reject, spam in e-mail accounts, and any other type of un-allowed content where spelling variants are typically used to avoid existing filters.

In some embodiments, a set of correctly spelled alert words and spelling variants thereof can be received. As a first example, consider the set of correctly spelled alert words including {stock, . . . , tax}, and the set of spelling variants including {5tock, sto©k, . . . , t@x, ta*}. Each pair of a correctly spelled alert word and one of its corresponding variants can be aligned as a sequence of joint multigrams. A joint multigram is a pair of a letter sequence from a correctly spelled alert word, and a character sequence from a non-orthographic spelling variant of possibly different length. For example, consider “ciagan” as an correctly spelled alert word, and “c/i/a/g/a/n” and “©i@gan” as spelling variants corresponding to “ciagan.” An example alignment between “ciagan” and “c/i/a/g/a/n” is shown below. Each pair such as {“g,” “/g”} is referred to as a joint multigram. Note that in the joint multigram {“g,” “/g”}, the correctly spelled component and the variant component have a different amount of characters.

TABLE 1

| | | | |
|---|---|---|---|
| Correctly spelled | cia | G | an |
| Variant | c/i/a | /g | /a/n |

A model capturing the correspondence between the joint multigrams of correctly spelled words and variant spellings can be trained using the alignments. Such training can include applying expectation-maximization (EM) using alignments as the hidden variable. In other embodiments, a Markov model or a graphical model can be used.

Once the model is trained, spelling variants can be observed from a content block. In the first example, consider a content block containing “hot penny st0©k tips.” The word “st0©k” is a spelling variant observation that may not have been included as a spelling variant in the training phase. Using the trained model, the probability that the spelling variant observation corresponds to a correctly spelled alert word can be determined as the sum of the probabilities over all possible alignments between the correctly spelled alert word and the spelling variant observation. In the first example using EM, a posterior probability that the spelling variant observation corresponds to a correctly spelled alert word can be determined.

For a determined probability greater than or equal to a configurable threshold, automatic acceptance of the content block can be denied. For example, where the content block forms part of an ad for an online ad network, the ad can be rejected or can undergo further review by an automated system or a human agent.

Turning now to the drawings, in which like numerals represent like (but not necessarily identical) elements throughout the figures, example embodiments of the present technology are described in detail.

### Example System Architectures

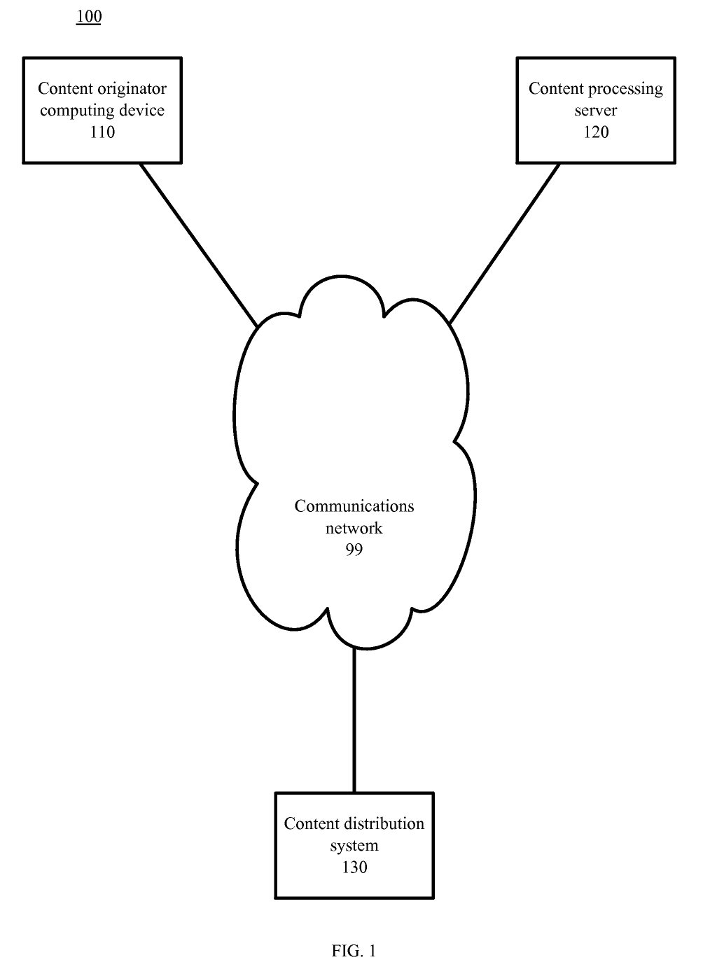

Referring to FIG. 1, an example architecture 100 for joint multigram-based detection of spelling variants is illustrated. While each server, system, and device shown in the architecture is represented by one instance of the server, system, or device, multiple instances of each can be used. Further, while certain aspects of operation of the present technology are presented in examples related to FIG. 1 to facilitate enablement of the example embodiment, additional features of the present technology, also facilitating enablement of the example embodiment, are disclosed elsewhere herein.

As depicted in FIG. 1, the architecture 100 includes network computing devices 110, 120, and 130; each of which may be configured to communicate with one another via communications network 99. In certain example embodiments, a user associated with a device must install an application and/or make a feature selection to obtain the benefits of the technology described herein.

Network 99 includes one or more wired or wireless telecommunications mechanisms by which network devices may exchange data. For example, the network 99 may include one or more of a local area network (LAN), a wide area network (WAN), an intranet, an Internet, a storage area network (SAN), a personal area network (PAN), a metropolitan area network (MAN), a wireless local area network (WLAN), a virtual private network (VPN), a cellular or other mobile communication network, a BLUETOOTH® wireless technology connection, a near field communication (NFC) connection, any combination thereof, and any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment.

Each network device can include a communication module capable of transmitting and receiving data over the network 99. For example, each network device can include a server, a desktop computer, a laptop computer, a tablet computer, a television with one or more processors embedded therein and/or coupled thereto, a smart phone, a handheld computer, a personal digital assistant (PDA), or any other wired or wireless processor-driven device. In the example embodiment depicted in FIG. 1, a content originator, such as an advertiser, may operate network device 110. A content processor, such as an advertisement distribution network operator, may operate network devices 120 and 130.

The network connections illustrated are example and other means of establishing a communications link between the computers and devices can be used. Moreover, those having ordinary skill in the art having the benefit of the present disclosure will appreciate that the network devices illustrated in FIG. 1 may have any of several other suitable computer system configurations. For example, content originator computing device 110 embodied as a mobile phone or handheld computer may not include all the components described above.

### Example Processes

The example embodiments illustrated in the following figures are described hereinafter with respect to the components of the example operating environment and example architecture described elsewhere herein. The example embodiments may also be performed with other systems and in other environments.

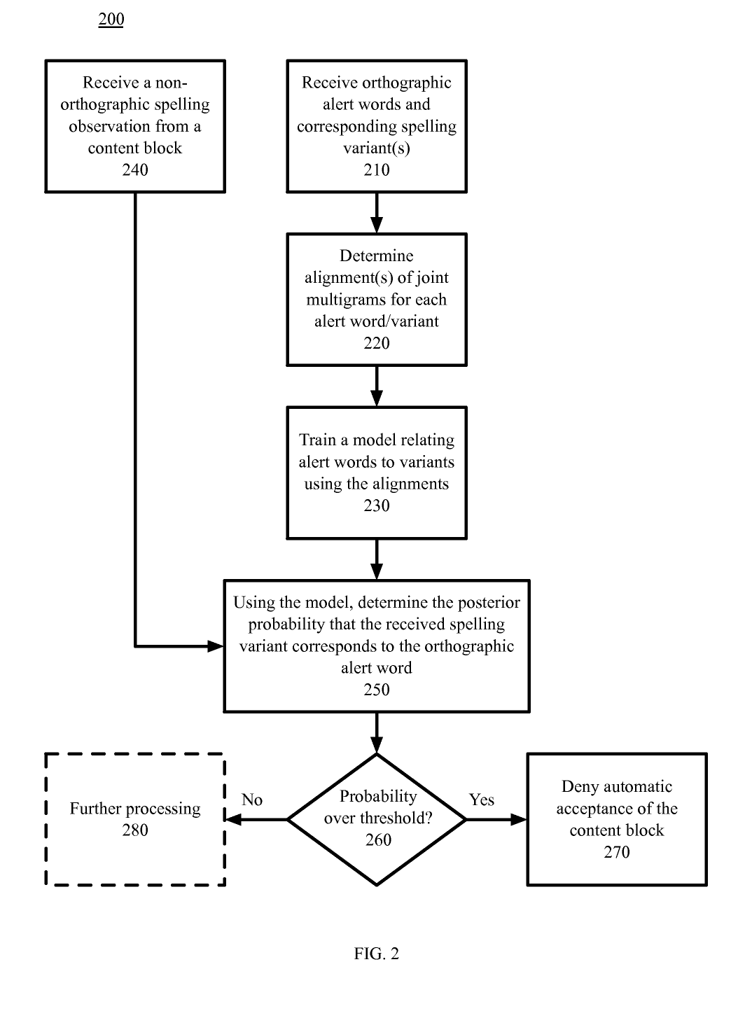

Referring to FIG. 2, and continuing to refer to FIG. 1 for context, example methods 200 for joint multigram-based detection of spelling variants in a content block are illustrated. In such methods, the content processing server 120 receives a set of a correctly spelled alert words and at least one spelling variant corresponding to each correctly spelled alert word—Block 210. Each correctly spelled alert word in the set of correctly spelled alert words is represented by a word φ in a set Φ of such words (φεΦ), while each corresponding variant in the set of variants is represented by variant g in a set G of such variants (gεG). Each correctly spelled alert word corresponds to one or more variants in the set of variants. As a continuing example, consider the set of correctly spelled alert words Φ={stock, . . . , tax}, and the set of spelling variants including G={5tock, sto©k, 5to©k . . . , t@x, ta*}. Accordingly, at least one spelling variant is received corresponding to each correctly spelled word.

Each pair of a correctly spelled alert word and one of its corresponding variants is aligned by the content processing server 120 as a sequence of joint multigrams—Block 220. A joint multigram is a pair of (1) a letter sequence from a correctly spelled alert word and (2) a character sequence from an incorrectly spelled variant of possibly different length. For example, consider “ciagan” as a correctly spelled alert word, and “c/i/a/g/a/n” and “©i@gan” as spelling variants corresponding to “ciagan.” Example alignments can include those shown below in TABLE 2 and TABLE 3. Each pair, such as {“g,” “/g”}, is referred to as a joint multigram. Note that in the example joint multigram {“g,” “/g”}, the correctly spelled component and the variant component have a different amount of characters.

TABLE 2

| | | | |
|---|---|---|---|
| Correctly spelled | cia | G | an |
| Variant | c/i/a | /g | /a/n |

TABLE 3

| Correctly spelled | c | ia | g | an |
|---|---|---|---|---|
| Variant | c | 1@ | g | @n |

Each variant can have multiple alignments with the same correctly spelled word. For example, TABLE 4 illustrates two alignments between correctly spelled “ciagan” and two of its corresponding variants.

TABLE 4
ALIGNMENT 1

| | | | |
|---|---|---|---|
| Correctly spelled | cia | g | an |
| Variant | c/i/a | /g | /a/n |

ALIGNMENT 2

| | | | |
|---|---|---|---|
| Correctly spelled | ci | ag | an |
| Variant | c/i | /a/g | /a/n |

The joint probability that a variant φ corresponds to an alert word g is the sum of the probabilities p(g,φ) across all possible alignments between the alert word and the variant, as shown in Equation (1), where S (g, φ) is the set of possible alignments.

p(g,φ)=Σ_{gεS(g,φ)}p(g) (1)

A model capturing the correspondence between the joint multigrams of correctly spelled words and variant spellings is trained using the alignments—Block 230. Various model training approaches, including hidden Markov, graphical models, and expectation maximization, can be used. This approach models the correspondence between correctly spelled/variant pairs, and between subgroups of characters of those words by using multigrams.

The content processing server 120 receives a spelling variant observation from a content block—Block 240. In the continuing example, “C!αgAn” is received as part of a content block for an advertisement to be placed in an advertisement distribution network—for example, for an advertisement to be placed on an search results page in response to a query for “ciagan.”

Using the trained model, the content processing server 120 determines a probability that the received spelling variant observation corresponds to a received correctly spelled alert word—Block 250. In certain examples, determining the probability that the received spelling variant observation corresponds to a received correctly spelled alert word includes determining a posterior probability that the received spelling variant observation corresponds to the orthographic alert word—Block 250. In the continuing example, the probability p(φ|g) that a received variant φ corresponds to an alert word g is the posterior probability given by Equation (2), where S (g, φ) is the set of possible alignments between “ciagan” and its variants.

$$p ( ϕ \vert g ) = \frac{{\sum }_{g ∈ S ( g , ϕ )} p ( g )}{p ( g )} \qquad ( 2 )$$

The content processing server 120 compares the determined probability to a predetermined threshold—Block 260. For a determined probability exceeding a configured threshold, Block 260 “Yes” path, the content processing server 120 denies automatic acceptance of the content block—Block 270. In the continuing example, the predetermined threshold is 0.75, and the posterior probability that “C!αgAn” corresponds to the alert word “ciagan” is 0.80. Therefore the advertisement containing a content block containing “C!αgAn” would be denied automatic acceptance as an appropriate ad to be placed on a search results page in response to a query for “ciagan.”

Conversely, for a determined probability not exceeding a configured threshold, Block 260 “No” path, the content processing server 120 continues processing the content block—Block 280. For example, the content distribution system 130 may examine the content block for compliance with a style sheet issued by the content distribution system operator.

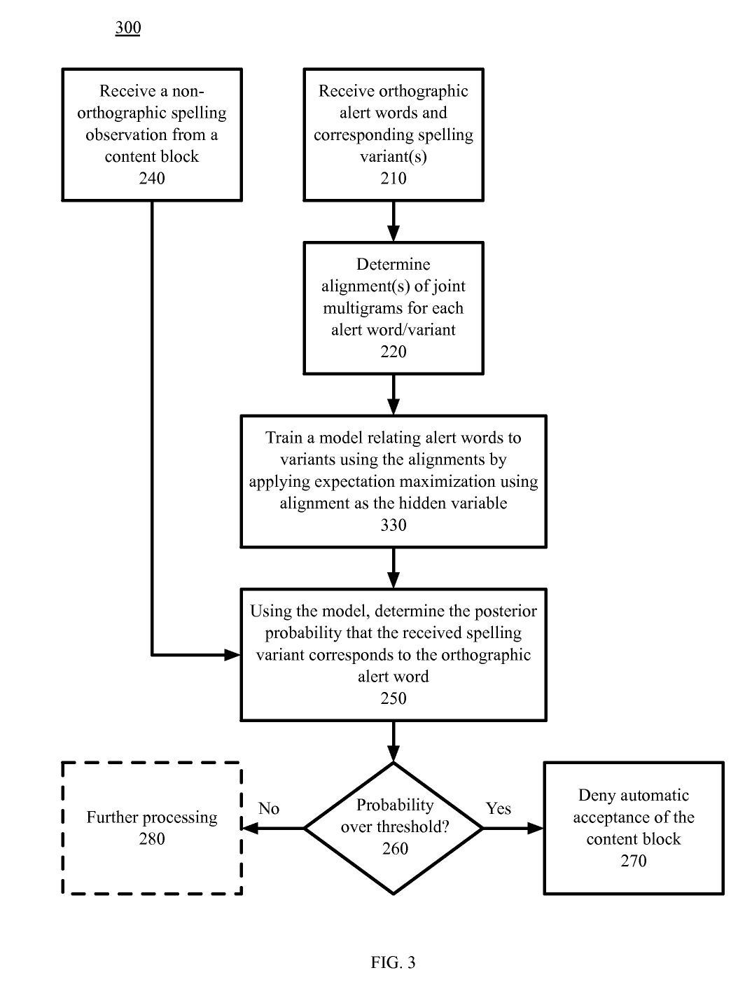

Referring to FIG. 3, and continuing to refer to prior figures for context, alternative example methods 300 for joint multigram-based detection of spelling variants in a content block are illustrated. In such methods, Blocks 210, 220, 240, 250, 260, and 270 are performed as described elsewhere herein. In such embodiments, training (as otherwise described with regard to Block 230) includes applying expectation-maximization (EM) using joint multigram alignment between correctly spelled alerts words and their corresponding variants as the hidden variable—Block 330. The EM algorithm finds the maximum likelihood or maximum a posteriori estimates of parameters in statistical models using an iterative approach. The expectation step creates a function for the expectation of the log-likelihood evaluated using the current estimate for the parameters. The maximization computes parameters maximizing the expected log-likelihood. The estimates are then used to determine the distribution of the latent variables in the next iteration.

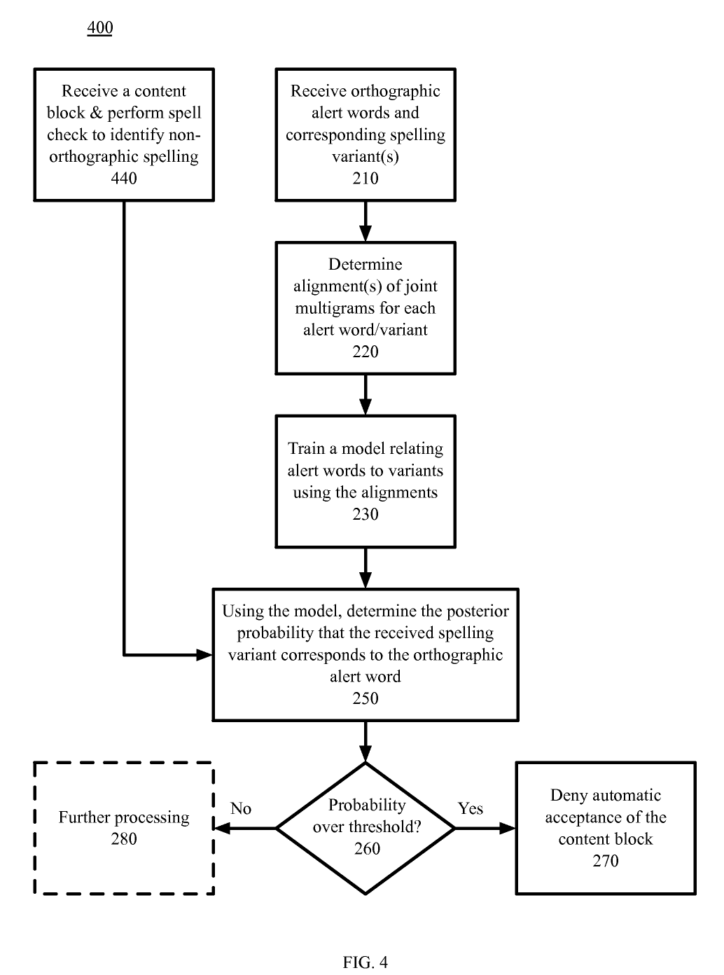

Referring to FIG. 4, and continuing to refer to prior figures for context, alternative example methods 400 for joint multigram-based detection of spelling variants in a content block are illustrated. In such methods, Blocks 210, 220, 230, 250, 260, and 270 are performed as described elsewhere herein. In such embodiments, receiving a spelling variant observation from a content block includes the content processing server 120 receiving the content block and performing a spell check function on the content block to identify each incorrect spelling as a spelling variant observation—Block 440. Each incorrect identified incorrect spelling is a candidate to be assessed by the trained model. For example, consider receiving the content block “Free 90-day trial of ©i@gan, delivered to your door.” Performing spell check on this block would result in identifying “©i@gan” as a spelling variant. In some cases, spelling variants can include non-printable characters or graphical elements, such as a Joint Photographic Experts Group (JPEG) image of a spelling variant or an image of a correctly spelled word, where the image may encompass the entire word or one or more individual characters of the word.

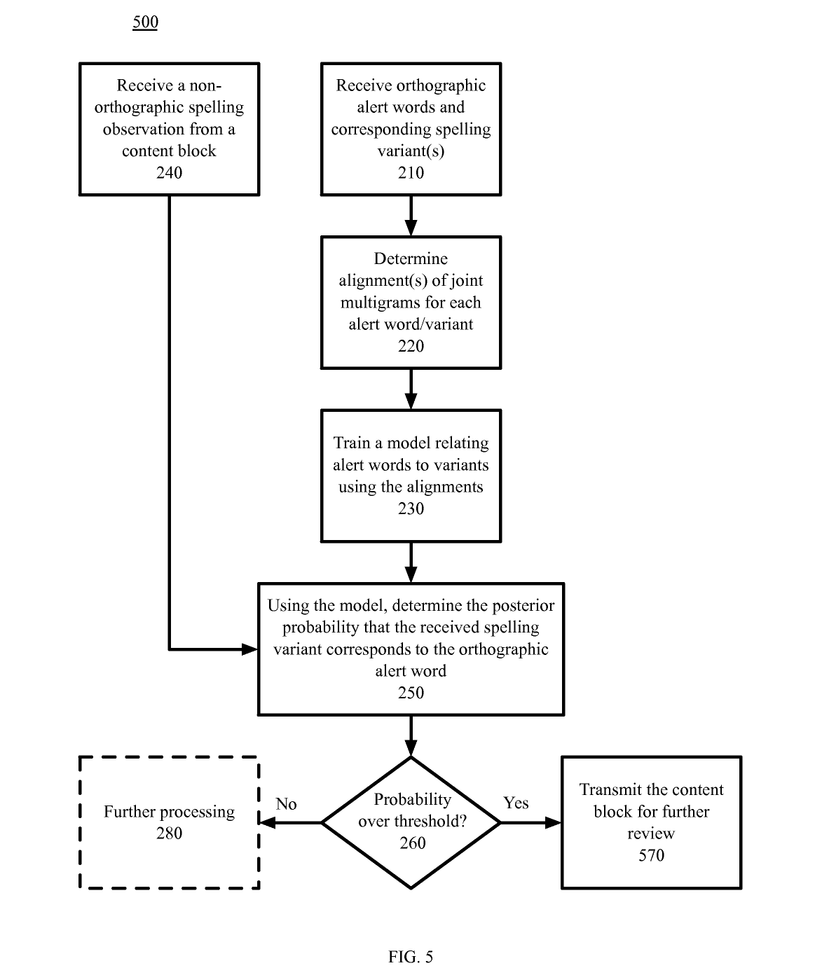

Referring to FIG. 5, and continuing to refer to prior figures for context, alternative example methods 500 for joint multigram-based detection of spelling variants in a content block are illustrated. In such methods, Blocks 210, 220, 230, 240, 250, and 260 are performed as described elsewhere herein. In such embodiments, denying automatic acceptance comprises transmitting the content block for further review—Block 570. In some embodiments, the content block, each variant detected in the content block, the corresponding correctly spelled alert word, and the determined probability that the variant corresponds to the correctly spelled alert word are transmitted for display in a graphical user interface (GUI) of a workstation of an operator. For example, while advertisements that do not contain alert words or spelling variants of alert words can be automatically accepted by the content distribution system 130, advertisements that contain alert words or spelling variants thereof can be transmitted for operator review. Upon a favorable operator review, such an advertisement can be placed in the content distribution system. Upon an unfavorable review, such an advertisement can be rejected, and the content originator can be notified of the rejection, for example by the content processing server 120 communicating with the content originator computing device 110.

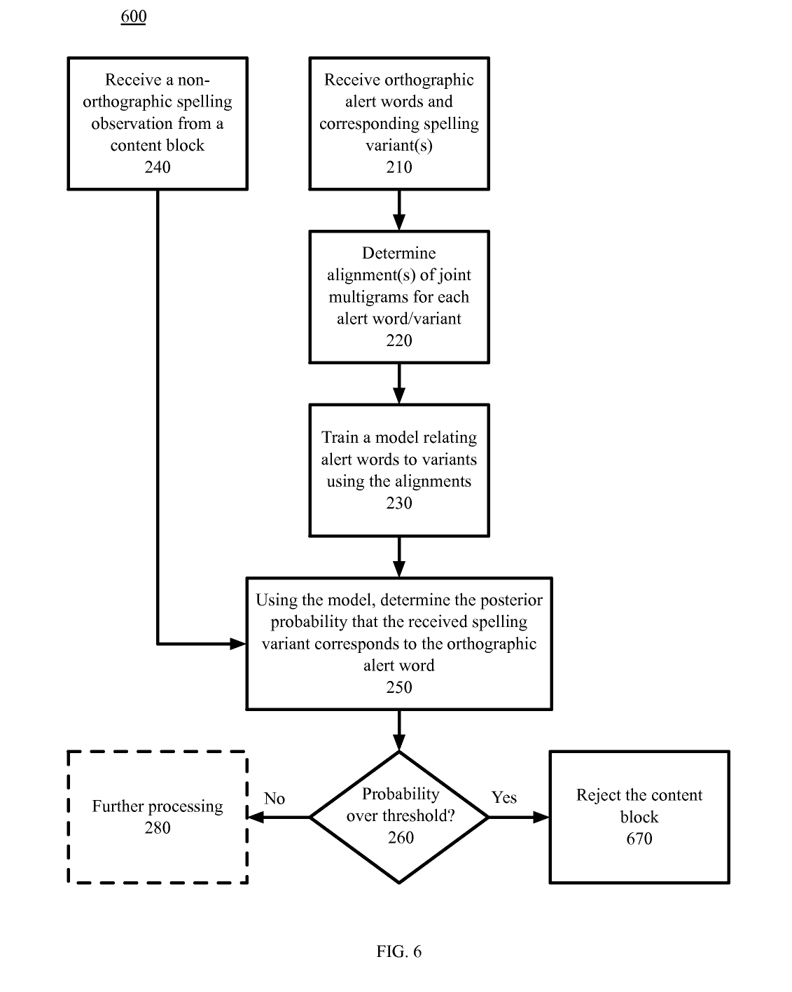

Referring to FIG. 6, and continuing to refer to prior figures for context, alternative example methods 600 for joint multigram-based detection of spelling variants in a content block are illustrated. In such methods, Blocks 210, 220, 230, 240, 250, and 260 are performed as described elsewhere herein. In such embodiments, denying automatic acceptance comprises rejecting the content block without further review—Block 670. For example, while advertisements that do not contain alert words or spelling variants of alert words can be automatically accepted by the content distribution system 130, advertisements that contain alert words or spelling variants thereof can without further review and the content originator can be notified of the rejection, for example by the content processing server 120 communicating with the content originator computing device 110.

In some embodiments, two configured thresholds can be used—a first configured threshold having a first value, and a second configured threshold having a greater value than the first configured threshold. For a determined probability exceeding a first configured threshold, the content processing server 120 transmits the content block for further review. For a determined probability exceeding the second configured threshold, the content processing server automatically rejects the content block without further review as described above.

### Other Example Embodiments

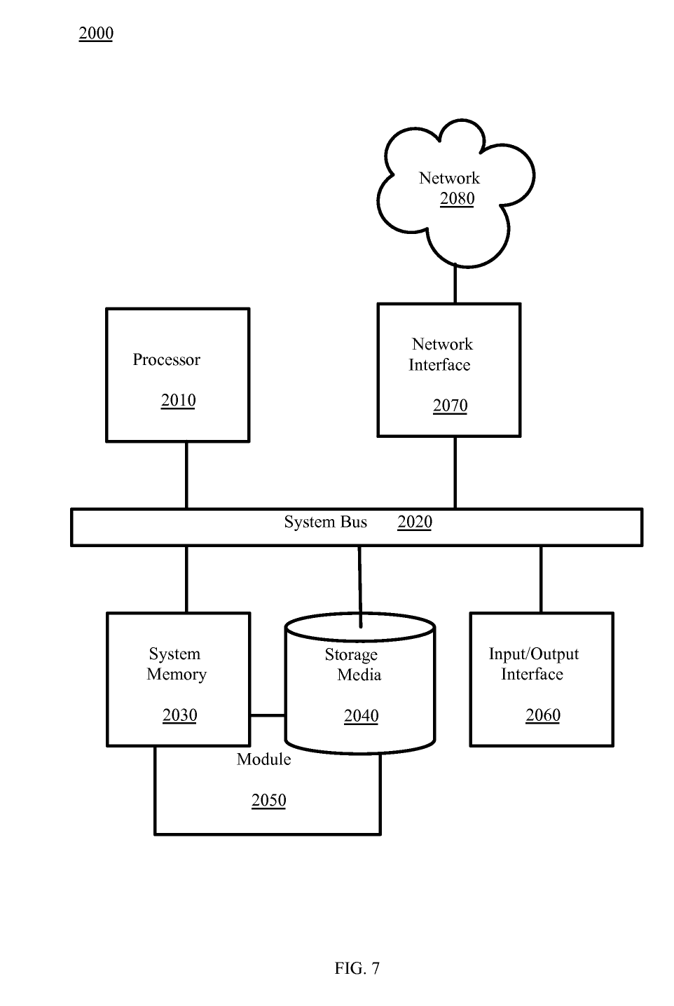

FIG. 7 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components, for example, a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (DSP), an application specific integrated circuit (ASIC), a graphics processing unit (GPU), a field programmable gate array (FPGA), a programmable logic device (PLD), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories, for example, read-only memory (ROM), programmable read-only memory (PROM), erasable programmable read-only memory (EPROM), flash memory, or any other device capable of storing program instructions or data with or without applied power. The system memory 2030 may also include volatile memories, for example, random access memory (RAM), static random access memory (SRAM), dynamic random access memory (DRAM), and synchronous dynamic random access memory (SDRAM). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device, for example, the storage media 2040.

The storage media 2040 may include a hard disk, a floppy disk, a compact disc read only memory (CD-ROM), a digital versatile disc (DVD), a Blu-ray disc, a magnetic tape, a flash memory, other non-volatile memory device, a solid state drive (SSD), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules, for example, module 2050, data, or any other information. The storage media 2040 may be part of, or connected to, the computing machine 2000. The storage media 2040 may also be part of one or more other computing machines that are in communication with the computing machine 2000, for example, servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits, for example, microcode or configuration information for an FPGA or other PLD.

The input/output (I/O) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, for example, small computer system interface (SCSI), serial-attached SCSI (SAS), fiber channel, peripheral component interconnect (PCI), PCI express (PCIe), serial bus, parallel bus, advanced technology attached (ATA), serial ATA (SATA), universal serial bus (USB), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media, for example, fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to certain example embodiments, any of the processor 2010, the other elements of the computing machine 2000, or the various peripherals discussed herein may be integrated into a single device, for example, a system on chip (SOC), system on package (SOP), or ASIC device.

In situations in which the technology discussed here collects personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (for example, to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the scope of the following claims, which are to be accorded the broadest interpretation so as to encompass such alternate embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures. For example, activities described in example embodiments as performed by the content processing server 120 can be allocated to, and performed by, other elements. For example, Block 260 can be performed by the content distribution system 130. As another example, spell check as described in conjunction with FIG. 4 can be performed as a preprocessing step prior to further processing by the content processing server 120.

We claim:

1. A method for content block processing, comprising:
receiving, by one or more computing devices, a set of correctly spelled alert words and at least one spelling variant corresponding to each correctly spelled alert word;
determining, by the one or more computing devices, at least one alignment of joint multigrams for each correctly spelled alert word/corresponding spelling variant pair;
training, by the one or more computing devices, a model of correspondence between the set of received correctly spelled alert words and corresponding spelling variants, and between subgroups of characters of those words using the determined joint multigram alignments;
receiving, by the one or more computing devices, a spelling variant observation from a content block;
using the trained model, determining, by the one or more computing devices, a probability that the received spelling variant observation corresponds to a received correctly spelled alert word; and
for a determined probability exceeding a configured threshold, denying, by the one or more computing devices, automatic acceptance of the content block.

2. The method of claim 1, wherein the training comprises applying expectation-maximization using alignment as the hidden variable.

3. The method of claim 2, wherein determining the probability that the received spelling variant observation corresponds to a received a correctly spelled alert word comprises determining a posterior probability that the received spelling variant observation corresponds to the orthographic alert word.

4. The method of claim 1, wherein receiving a spelling variant observation from a content block comprises receiving the content block and performing a spell check function on the content block to identify each incorrect spelling as a spelling variant observation.

5. The method of claim 1, wherein denying automatic acceptance comprises transmitting the content block for further review.

6. The method of claim 1, wherein denying automatic acceptance comprises rejecting the content block.

7. The method of claim 1, wherein the spelling variant includes at least one of a non-printable character and a graphical element.

8. A computer program product, comprising:
a non-transitory computer-readable storage device having computer-executable program instructions embodied thereon that when executed by a computer cause the computer to detect spelling variants, the computer-executable program instructions comprising:
computer-executable program instructions to receive a set of a correctly spelled alert words and at least one spelling variant corresponding to each correctly spelled alert word;
computer-executable program instructions to determine at least one alignment of joint multigrams for each correctly spelled alert word/corresponding spelling variant pair;
computer-executable program instructions to train a model of correspondence between the set of received correctly spelled alert words and corresponding spelling variants, and between subgroups of characters of those words using the determined joint multigram alignments;
computer-executable program instructions to receive a spelling variant observation from a content block;
computer-executable program instructions to determine, using the trained model, a probability that the received spelling variant observation corresponds to a received correctly spelled alert word; and
computer-executable program instructions to deny, for a determined probability exceeding a configured threshold, automatic acceptance of the content block.

9. The computer program product of claim 8, wherein the computer-executable program instructions to train comprise computer-executable program instructions to apply expectation-maximization using alignment as the hidden variable.

10. The computer program product of claim 9, wherein the computer-executable program instructions to determine the probability that the received spelling variant observation corresponds to a received a correctly spelled alert word comprise computer-executable program instructions to determine a posterior probability that the received spelling variant observation corresponds to the orthographic alert word.

11. The computer program product of claim 8, wherein the computer-executable program instructions to receive a spelling variant observation from a content block comprise the computer-executable program instructions to receive the content block and perform a spell check function on the content block to identify each incorrect spelling as a spelling variant observation.

12. The computer program product of claim 8, wherein the computer-executable program instructions to deny automatic acceptance comprise computer-executable program instructions to transmit the content block for further review.

13. The computer program product of claim 8, wherein the computer-executable program instructions to deny automatic acceptance comprise computer-executable program instructions to reject the content block.

14. The computer program product of claim 8, wherein the spelling variant includes at least one of a non-printable character and a graphical element.

15. A system for detection of spelling variants in a content block, comprising:
a storage device; and
a processor communicatively coupled to the storage device, wherein the processor executes application code instructions that are stored in the storage device to cause the system to:
receive a set of a correctly spelled alert words and at least one spelling variant corresponding to each correctly spelled alert word;
determine at least one alignment of joint multigrams for each correctly spelled alert word/corresponding spelling variant pair;
train a model of correspondence between the set of received correctly spelled alert words and corresponding spelling variants, and between subgroups of characters of those words using the determined joint multigram alignments;
receive a spelling variant observation from a content block;
determine, using the trained model, a probability that the received spelling variant observation corresponds to a received correctly spelled alert word; and
deny, for a determined probability exceeding a configured threshold, automatic acceptance of the content block.

16. The system of claim 15, wherein the training comprises applying expectation-maximization using alignment as the hidden variable.

17. The system of claim 16, wherein determining the probability that the received spelling variant observation corresponds to a received a correctly spelled alert word comprises determining a posterior probability that the received spelling variant observation corresponds to the orthographic alert word.

18. The system of claim 15, wherein receiving a spelling variant observation from a content block comprises: receiving the content block, and performing a spell check function on the content block to identify each incorrect spelling as a spelling variant observation.

19. The system of claim 15, wherein denying automatic acceptance comprises transmitting the content block for further review.

20. The system of claim 15, wherein denying automatic acceptance comprises rejecting the content block.
